(19) United States
(12) Patent Application Publication
(10) Pub. No.: US 2011/0295394 A1
(43) Pub. Date: Dec. 1, 2011

(54) METHOD FOR OUTPUTTING AUDIO DATA HAVING SPECIFIC AUDIO FORMAT TO AUDIO OUTPUT DEVICE AND ASSOCIATED CIRCUIT AND MULTIMEDIA PLAYER

(76) Inventor: Ping Zhao, Anhui Province (CN)

(21) Appl. No.: 12/808,184

(22) PCT Filed: May 26, 2010
(86) PCT No.: PCT/CN10/73255

§ 371 Date: Jun. 15, 2010

(51) Int. Cl. G06F 17/00

(52) U.S. Cl. 700/94

(57) ABSTRACT

A method for outputting audio data having a specific audio format to an audio output device includes: selecting the specific audio format from among a plurality of audio formats according to a table, wherein the table comprises information indicating which audio format is recommended for the audio output device; and outputting the audio data having the specific audio format to the audio output device.

### FIELD OF INVENTION

The present invention relates to an audio data outputting method, and more particularly, to a method for outputting audio data having a specific audio format to an audio output device, and an associated circuit and a multimedia player.

### BACKGROUND OF THE INVENTION

The DVD (Digital Versatile Disc) or BD (Blu-ray Disc) supports many audio formats such as AC3, Dolby, mp3 . . . etc. When audio data of a DVD or BD movie is played on an audio output device, however, such as a TV, speaker or earphone, a user may not know which audio format is recommended so that the particular audio output device has better performance. Therefore, the user may not get the best audio experience when watching this movie.

### SUMMARY OF THE INVENTION

It is therefore an objective of the present invention to provide a method for outputting audio data having a specific audio format to an audio output device, where the specific audio format is selected from among a plurality of audio formats according to information indicating which audio format is recommended for the audio output device, to solve the above-mentioned problem.

According to one embodiment of the present invention, a method for outputting audio data having a specific audio format to an audio output device comprises: selecting the specific audio format from among a plurality of audio formats according to a table, wherein the table comprises information indicating which audio format is recommended the audio output device; and outputting the audio data having the specific audio format to the audio output device.

According to another embodiment of the present invention, a circuit for outputting audio data having a specific audio format to an audio output device comprises a processing circuit and a storage device storing a program code. When the program code is executed by the processing circuit, the processing circuit selects the specific audio format from among a plurality of audio formats according to a table and outputs the audio data having the specific audio format to the audio output device, where the table comprises information indicating which audio format is recommended for the audio output device.

According to another embodiment of the present invention, a multimedia player for outputting audio data having a specific audio format to an audio output device comprises a reader and a processing circuit. The reader is used for reading at least audio information from a storage medium, where the audio information comprises a plurality of audio formats which the storage medium supports. The processing circuit is used for selecting the specific audio format from among the plurality of audio formats according to a table, where the table comprises information indicating which audio format is recommended for the audio output device. The processing circuit then processes data read from the storage medium to generate the audio data having the specific audio format, and outputs the audio data having the specific audio format to the audio output device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a multimedia player according to one embodiment of the present invention.

FIG. 2 is a flowchart of a method for outputting audio data having a specific audio format to a speaker according to one embodiment of the present invention.

FIGS. 3A, 3B and 3C show embodiments of a table of audio formats.

FIG. 4 is a diagram illustrating a multimedia player according to another embodiment of the present invention.

FIG. 5 illustrates an example of uploading speaker information to the host.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

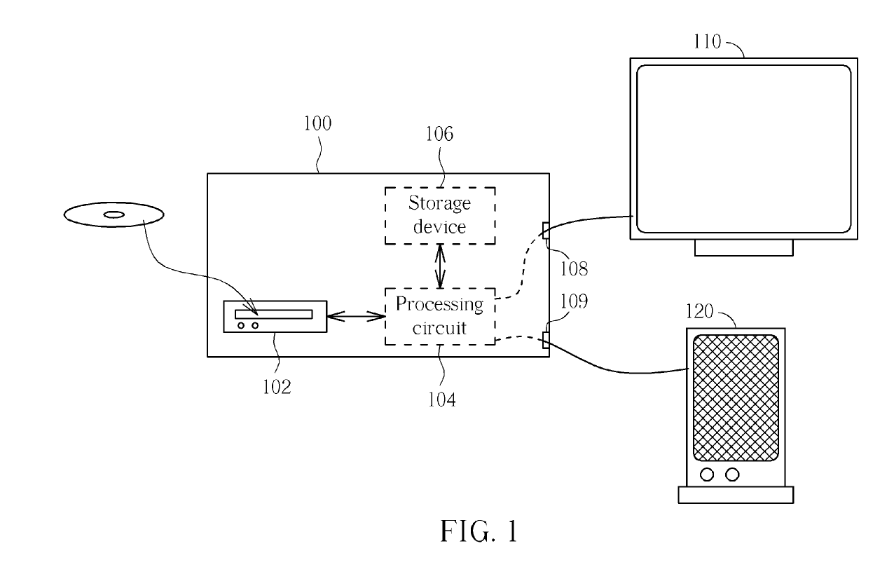

Please refer to FIG. 1. FIG. 1 is a diagram illustrating a multimedia player 100 according to one embodiment of the present invention. As shown in FIG. 1, the multimedia player 100 includes a reader 102, a processing circuit 104, a storage device 106, and two interfaces 108 and 109. The reader 102 is utilized for reading a storage medium (in this embodiment, a disc supporting a plurality of audio formats, such as a DVD movie or BD movie, serves as the storage medium), a storage device 106 is utilized for storing a table (not shown), and the interfaces 108 and 109 are utilized for connecting to a monitor 110 and an audio output device (in this embodiment, a speaker 120 serves as the audio output device).

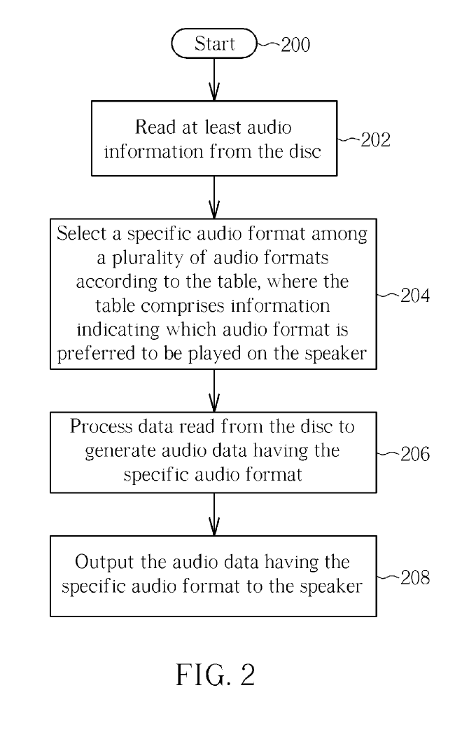

Please refer to FIG. 1 and FIG. 2 together. FIG. 2 is a flowchart of a method for outputting audio data having a specific audio format to the speaker 120 according to one embodiment of the present invention. Referring to FIG. 2, the flow is described as follows:

In Step 200, the disc is put into the multimedia player 100. In Step 202, the reader 102 reads at least audio information from the disc, where the audio information indicates which audio formats are provided by the disc. Then, in Step 204, the processing circuit 104 selects a specific audio format from among a plurality of audio formats provided in Step 202 according to the table stored in the storage device 106, where the table comprises information indicating which audio format is recommended for the speaker 120. In Step 206, the processing circuit 104 processes data read from the disc to generate audio data having the specific audio format. Finally, in Step 208, the processing circuit 104 outputs the audio data having the specific audio format to the speaker 120.

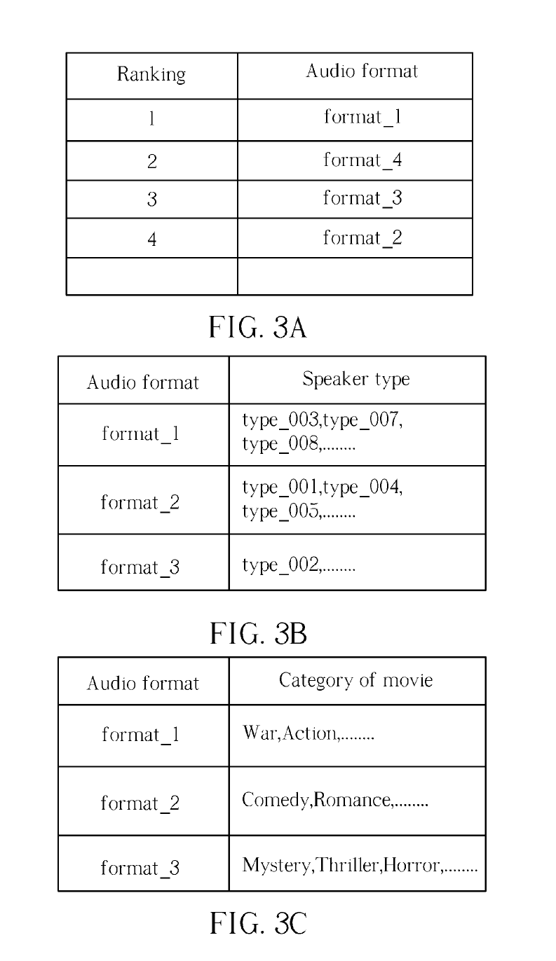

FIGS. 3A, 3B and 3C show embodiments of the table. As shown in FIG. 3A, the table comprises a preference ranking of audio formats as shown in FIG. 3, where the ranking shown in FIG. 3A can be determined by the type of speaker 120, a playback environment, and/or any other factor which may influence the audio playback quality. Referring to FIG. 3B, the table indicates a plurality of types of speakers and at least one audio format which is recommended for each of the plurality of types of speakers, where the type of speaker here can be a brand of the speaker, a model/type of the speaker, a function of the speaker . . . etc. In addition, as shown in FIG. 3C, if the disc is a DVD or BD movie, the table indicates a plurality of categories of movies and at least one audio format which is recommended for each of the plurality of categories of movies.

The table shown in FIGS. 3A-3C can be displayed on the monitor 110 to allow a user to use a remote controller to select an audio format, and the processing circuit 104 can determine the specific audio format (i.e., the user selected audio format) from among the plurality of audio data according to the user's input. In addition, after the user selects an audio format based on the table, this user-selected audio format can be set as a default audio format of the multimedia player 100.

In addition, in another embodiment, the processing circuit 104 can detect the type of speaker 120 or the category of the movie disc to automatically select the specific audio format according to the table comprising the information indicating which audio format is recommended for the speaker 120.

In another embodiment, the storage device 106 can further store a program code, and the processing circuit 104 can perform steps 204-208 shown in FIG. 2 when the program code is executed by the processing circuit 104.

In addition, the storage device 106 and the processing circuit 104 shown in FIG. 1 are independent circuits. In another embodiment, however, the storage device 106 can be built in the processing circuit 106. This alternative design also falls within the scope of the present invention.

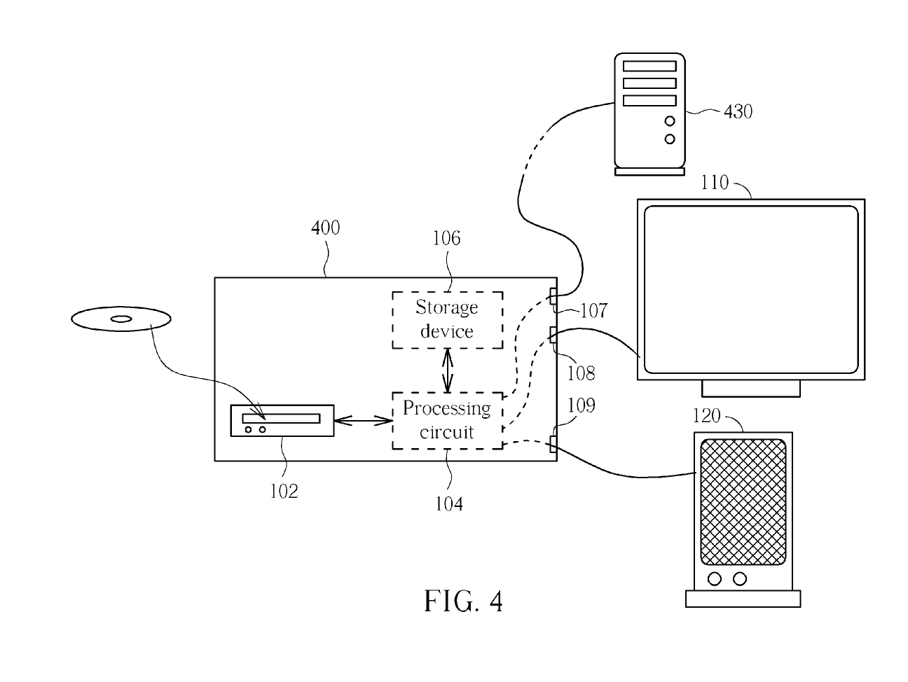

Please refer to FIG. 4. FIG. 4 is a diagram illustrating a multimedia player 400 according to another embodiment of the present invention. As shown in FIG. 4, the multimedia player 400 is similar to the multimedia player 100 shown in FIG. 1, but the multimedia player 400 further comprises a network interface 107 to connect to a host 430 via a network. In this embodiment, the multimedia player 400 connects to a network and downloads the table from the host 430 via the network, where the table comprises information indicating which audio format is recommended for the speaker 120. Then, the processing circuit 104 selects a specific audio format from among a plurality of audio formats according to the table downloaded from the host, and then the processing circuit 104 processes data read from the disc to generate audio data having the specific audio format, and outputs the audio data having the specific audio format to the speaker 120.

Furthermore, in another embodiment, the user can use the multimedia player 400 and the monitor 110 to upload information of the speaker 120 to the host 430 via the network, where the information of the speaker 120 can be a brand of the speaker 120, a number of speakers, a playback environment, or any information that is a combination of the above-mentioned information. In this way, the host 430 can provide the table according to the user-uploaded information, and the user can download this table from the host 430.

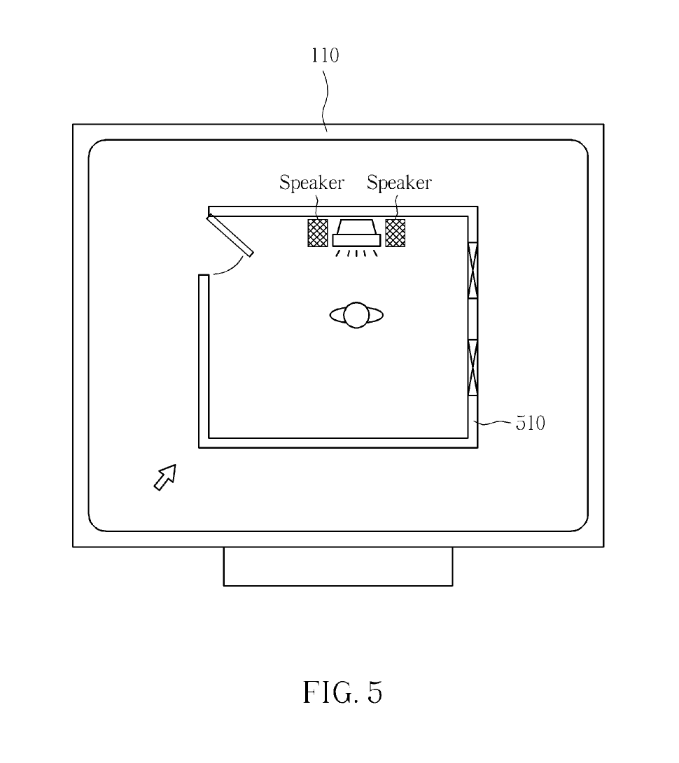

FIG. 5 is taken as an example for describing the above-mentioned uploading of the information of the speaker 120 to the host 430. Referring to FIG. 5, assuming that the host 430 includes a website, the user can input various information of the speaker 120, such as a number of speakers, position(s) of the speaker in a room 510, a layout of the room 510, and a position of the user hearing the audio generated from the speaker, alone or in combination, to the website via the monitor 110.

Briefly summarized, in the present invention, a table comprising information indicating which audio format is recommended for an audio output device is provided for selecting a specific audio format from among a plurality of audio formats. Therefore, a variety of media played through the audio output device will have an improved audio performance.

Those skilled in the art will readily observe that numerous modifications and alterations of the device and method may be made while retaining the teachings of the invention.

1. A method for outputting audio data having a specific audio format to an audio output device, comprising:
selecting the specific audio format from among a plurality of audio formats according to a table, wherein the table comprises information indicating which audio format is recommended for the audio output device; and
outputting the audio data having the specific audio format to the audio output device.

2. The method of claim 1, wherein the plurality of audio formats are sorted in the table according to a preference ranking of audio formats.

3. The method of claim 1, wherein the information in the table indicates a plurality of types of audio output devices and at least one audio format which is recommended for each of the plurality of types of audio output devices.

4. The method of claim 1, wherein the plurality of audio data are audio data of a movie, and the information in the table indicates a plurality of categories of movies and at least one audio format which is recommended for each of the plurality of categories of movies.

5. The method of claim 1, wherein the method is employed in a multimedia player, and the method further comprises:
setting the specific audio format as a default audio format of the multimedia player.

6. The method of claim 1, further comprising:
downloading the table via a network.

7. The method of claim 1, further comprising:
connecting to a network; and
uploading information of the audio output device to a host via the network;
wherein the step of downloading the table comprises:
downloading the table from the host via the network.

8. The method of claim 7, wherein the information of the audio output device comprises position information of the audio output device in a playback environment.

9. The method of claim 1, wherein the step of selecting the specific audio data comprises:
selecting the specific audio data from among the plurality of audio data according to a user's input generated based on the table.

10. A circuit for outputting audio data having a specific audio format to an audio output device, comprising:
a processing circuit; and
a storage device, storing a program code;
wherein when the program code is executed by the processing circuit, the processing circuit selects the specific audio format from among a plurality of audio formats according to a table, where the table comprises information indicating which audio format is recommended for the audio output device; and the processing circuit outputs the audio data having the specific audio format to the audio output device.

11. The circuit of claim 10, wherein the plurality of audio formats are sorted in the table according to a preference ranking of audio formats.

12. The circuit of claim 10, wherein the information in the table indicates a plurality of types of audio output devices and at least one audio format which is recommended for each of the plurality of types of audio output devices.

13. The circuit of claim 10, wherein the plurality of audio data are audio data of a movie, and the information in the table indicates a plurality of categories of movies and at least one audio format which is recommended for each of the plurality of categories of movies.

14. The circuit of claim 10, wherein the processing circuit selects the specific audio data from among the plurality of audio data according to a user's input generated based on the table.

15. A multimedia player for outputting audio data having a specific audio format to an audio output device, comprising:
a reader, for reading at least audio information from a storage medium, wherein the audio information indicates a plurality of audio formats supported by the storage medium; and
a processing circuit, coupled to the reader, for selecting the specific audio format from among the plurality of audio formats according to a table, wherein the table comprises information indicating which audio format is recommended for the audio output device;
wherein the processing circuit processes data read from the storage medium to generate the audio data having the specific audio format, and outputs the audio data having the specific audio format to the audio output device.

16. The multimedia player of claim 15, wherein the information in the table indicates a plurality of types of audio output devices and at least one audio format which is recommended for each of the plurality of types of audio output devices.

17. The multimedia player of claim 15, wherein the plurality of audio data are audio data of a movie, and the information in the table indicates a plurality of categories of movies and at least one audio format which is recommended for each of the plurality of categories of movies.

18. The multimedia player of claim 15, wherein the processing circuit connects to a network and uploads information of the audio output device to a host via the network, and downloads the table from the host via the network.

19. The multimedia player of claim 18, wherein the information of the audio output device comprises position information of the audio output device in a playback environment.
